(19) United States
(12) Patent Application Publication
(10) Pub. No.: US 2026/0091520 A1
(43) Pub. Date: Apr. 2, 2026

(54) VERTICAL ARTICULATED ROBOT

(71) Applicant: SEIKO EPSON CORPORATION, Tokyo (JP)

(72) Inventor: Daichi TAKAHARA, MATSUMOTO-SHI (JP)

(21) Appl. No.: 19/342,301

(22) Filed: Sep. 26, 2025

(30) Foreign Application Priority Data
Sep. 27, 2024 (JP) 2024-169636

(51) Int. Cl. B25J 19/00; B25J 9/04; B25J 9/10

(52) U.S. Cl. CPC B25J 19/0029; B25J 9/046; B25J 9/104

(57) ABSTRACT

A vertical articulated robot includes a first arm; a second arm coupled to a distal end portion of the first arm, configured to rotate around a first rotation axis with respect to the first arm, and extending along the first rotation axis; and a third arm coupled to a distal end portion of the second arm and configured to rotate around a second rotation axis with respect to the second arm. The second arm includes a housing coupled to the first arm; and a first wire lead-out portion and a second wire lead-out portion disposed on the housing. The first wire lead-out portion leads out a first wire to the outside of the housing, and the second wire lead-out portion leads out a second wire to the outside of the housing. The first and the second wire lead-out portions are disposed to face each other across the first rotation axis.

### CROSS-REFERENCE TO RELATED APPLICATIONS

The present application is based on, and claims priority from JP Application Serial Number 2024-169636, filed September 27, 2024, the disclosure of which is hereby incorporated by reference herein in its entirety.

### BACKGROUND OF THE INVENTION

### 1. Technical Field

The present disclosure relates to a vertical articulated robot.

### 2. Related Art

A robot described in JP-A-2019-162700 is a six-axis vertical articulated robot and includes an arm in which six arm members are rotatably coupled to each other and a tool attached to a distal end of the arm. Hereinafter, for convenience of description, the six arm members are also referred to as a first arm member, a second arm member, a third arm member, a fourth arm member, a fifth arm member, and a sixth arm member, in order from a proximal side of the arm. In the robot described in JP-A-2019-162700, wires are led out from a side surface on one side of the fourth arm member and the wires are coupled to the tool.

However, in such a configuration, the wires and a lead-out portion for leading out the wires are disposed only on one side surface of the fourth arm member. For this reason, there is a concern that a lateral balance of the fourth arm member may be lost and a center of gravity around a rotation axis of the fourth arm member may be deviated, and the operation performance of the arm may be deteriorated.

### SUMMARY OF THE INVENTION

A vertical articulated robot according to an aspect of the present disclosure includes: a first arm; a second arm coupled to a distal end portion of the first arm, configured to rotate around a first rotation axis with respect to the first arm, and extending along the first rotation axis; and a third arm coupled to a distal end portion of the second arm and configured to rotate around a second rotation axis with respect to the second arm. The second arm includes: a housing coupled to the first arm; and a first wire lead-out portion and a second wire lead-out portion disposed on the housing. The first wire lead-out portion leads out a first wire to the outside of the housing, the first wire being routed from the inside of the first arm to the inside of the housing, and the second wire lead-out portion leads out a second wire to the outside of the housing, the second wire being routed from the inside of the first arm to the inside of the housing. The first wire lead-out portion and the second wire lead-out portion are disposed to face each other across the first rotation axis.

### BRIEF DESCRIPTION OF DRAWINGS

FIG. 1 is a side view illustrating a vertical articulated robot according to a preferred embodiment.

FIG. 2 is a sectional view of arms included in the vertical articulated robot illustrated in FIG. 1.

FIG. 3 is a sectional view illustrating a configuration of drive units.

FIG. 4 is a plan view of arms for explaining a problem with a structure in the related art.

FIG. 5 is a plan view of arms.

FIG. 6 is a side view illustrating a state in which arms and a hand are coupled with wires.

FIG. 7 is a side view illustrating a state in which arms and a hand are coupled with wires.

### DETAILED DESCRIPTION OF THE INVENTION

Hereinafter, a vertical articulated robot according to the present disclosure will be described in detail based on embodiments illustrated in the accompanying drawings.

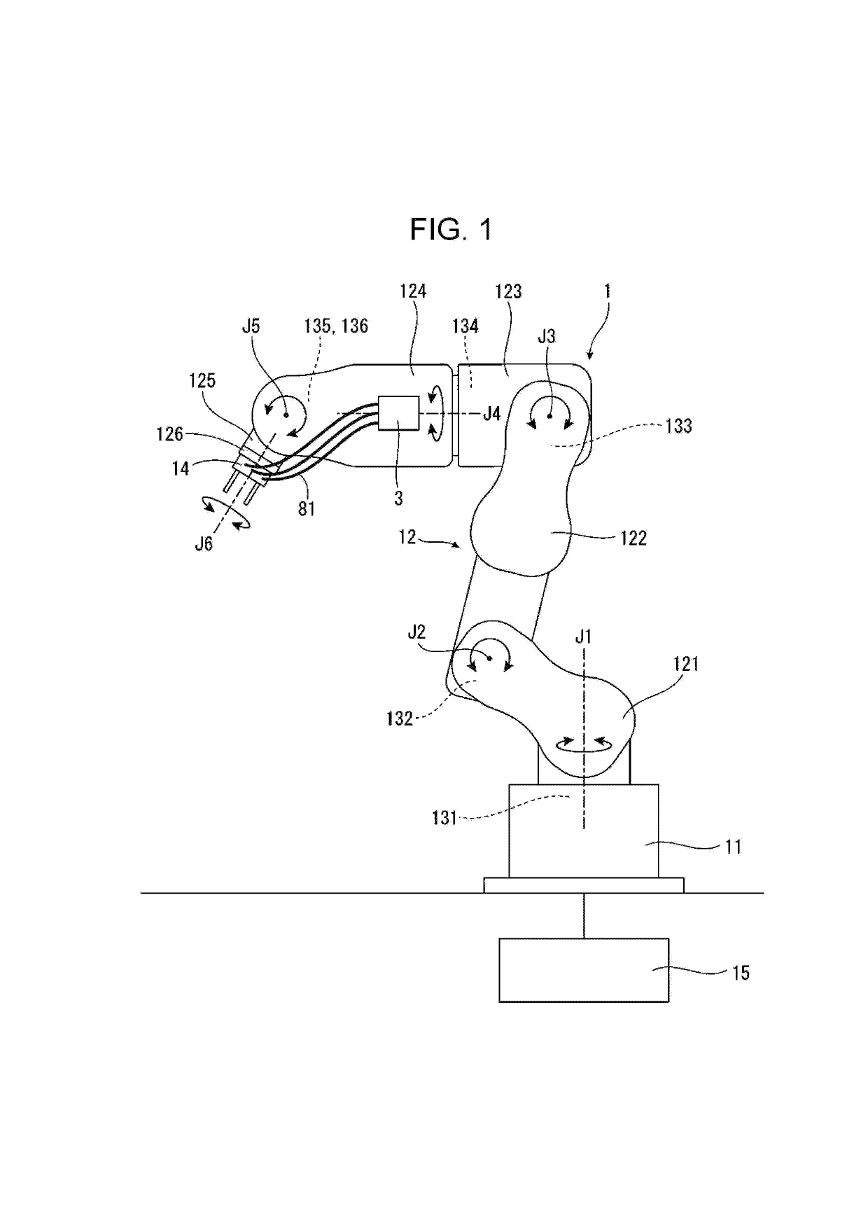

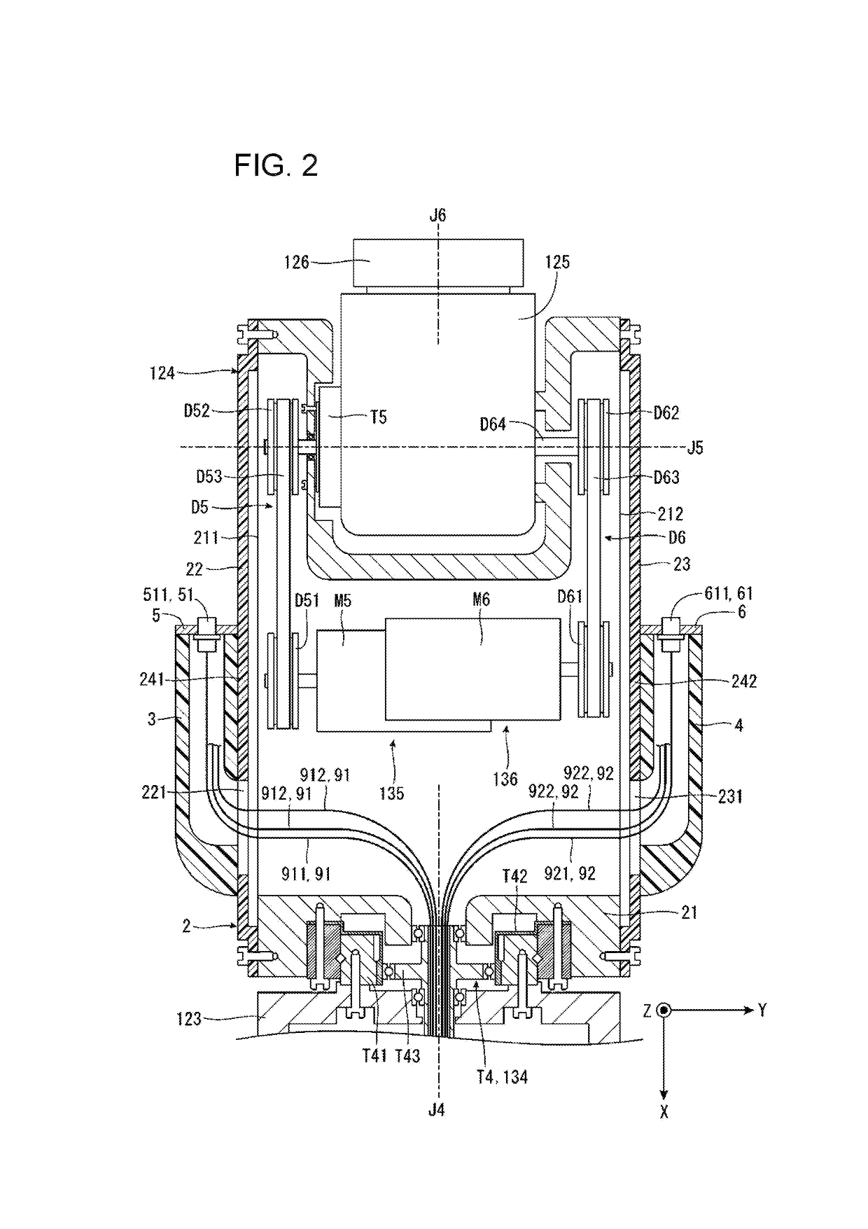

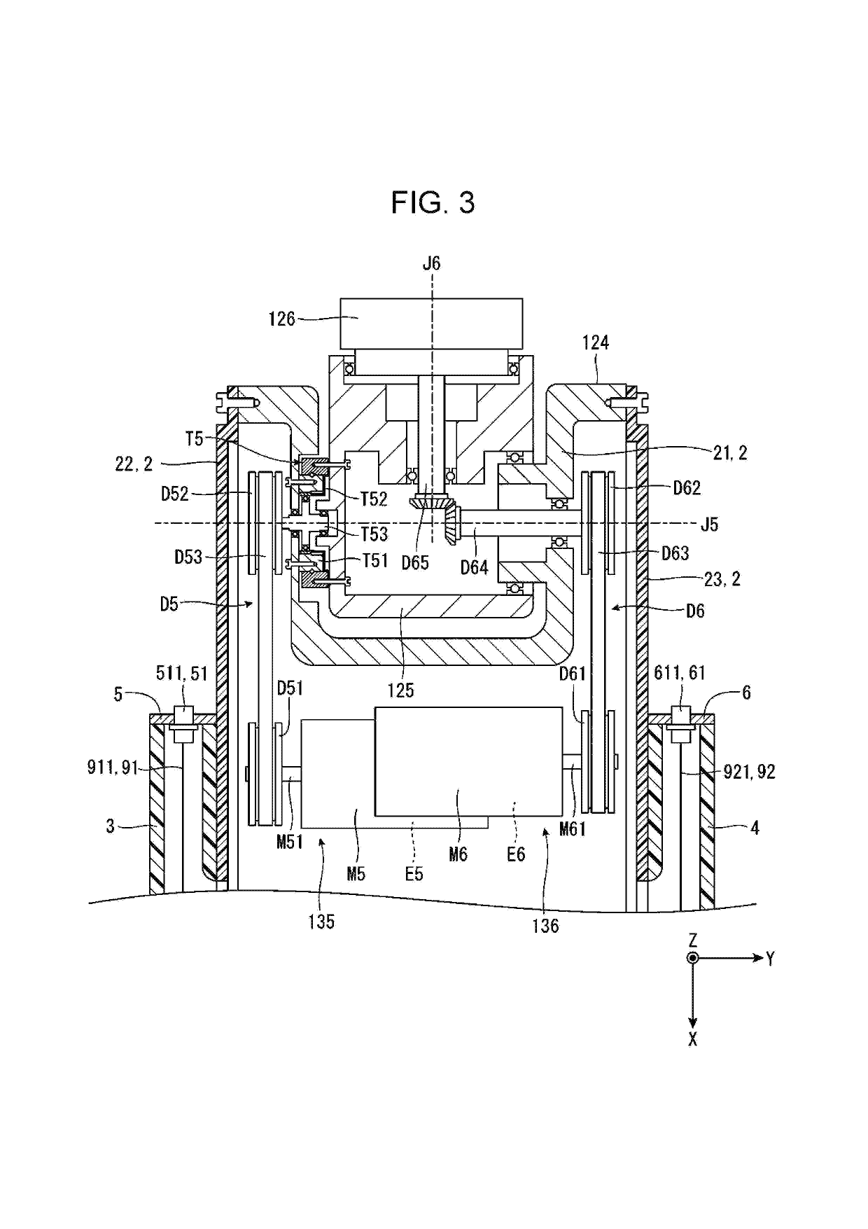

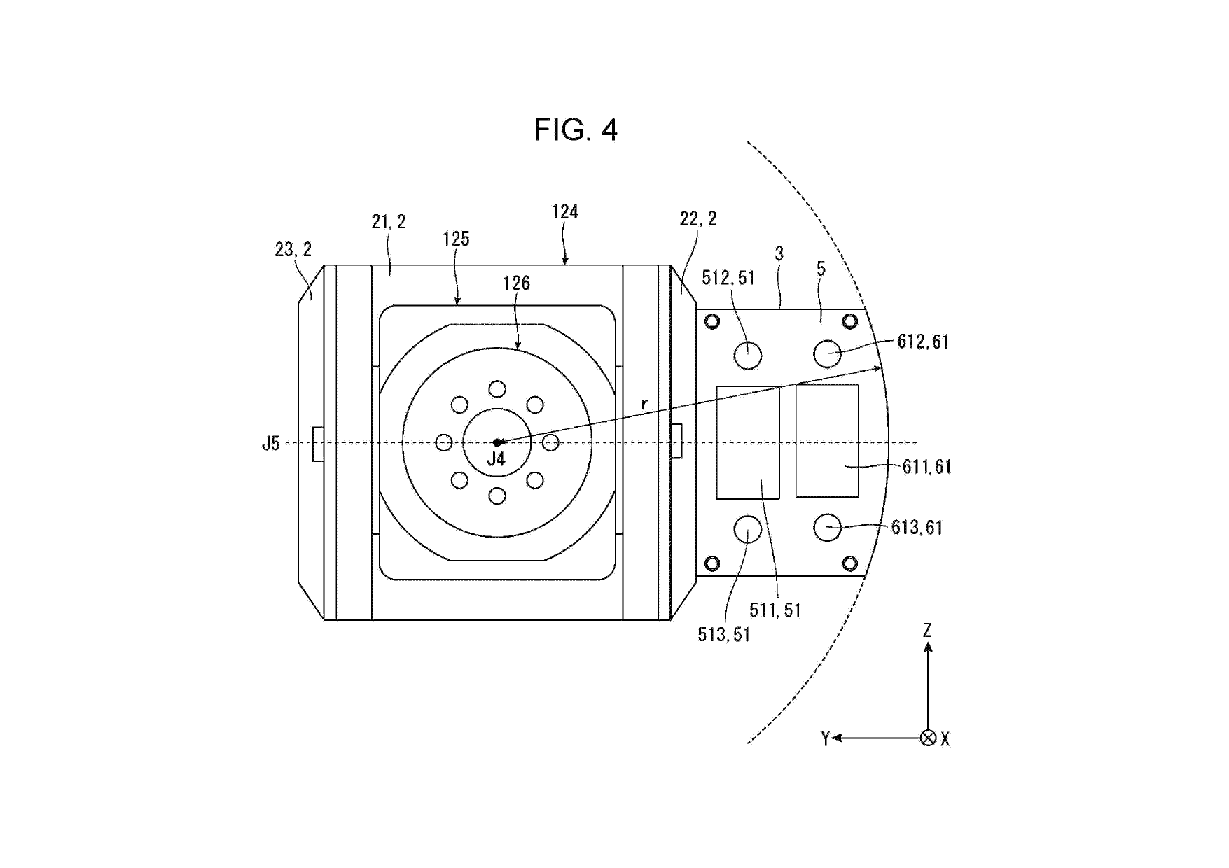

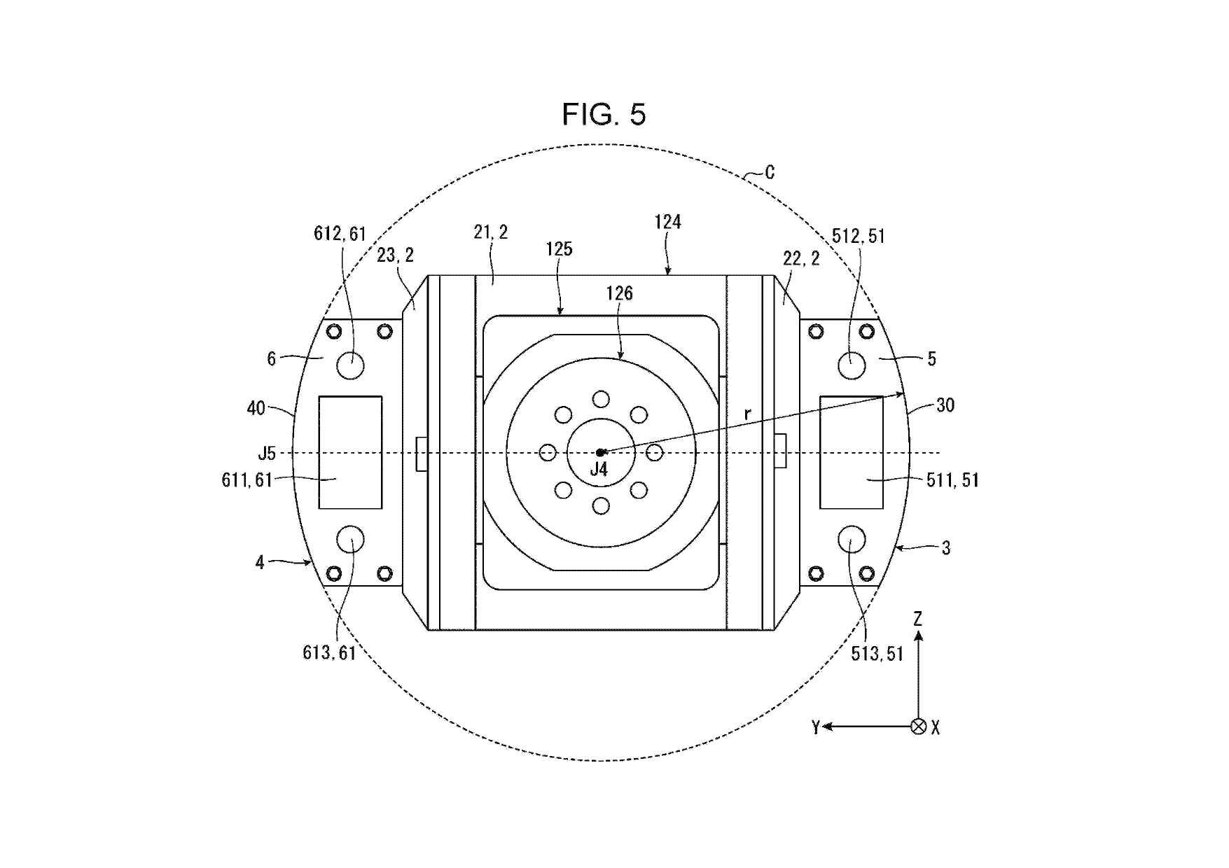

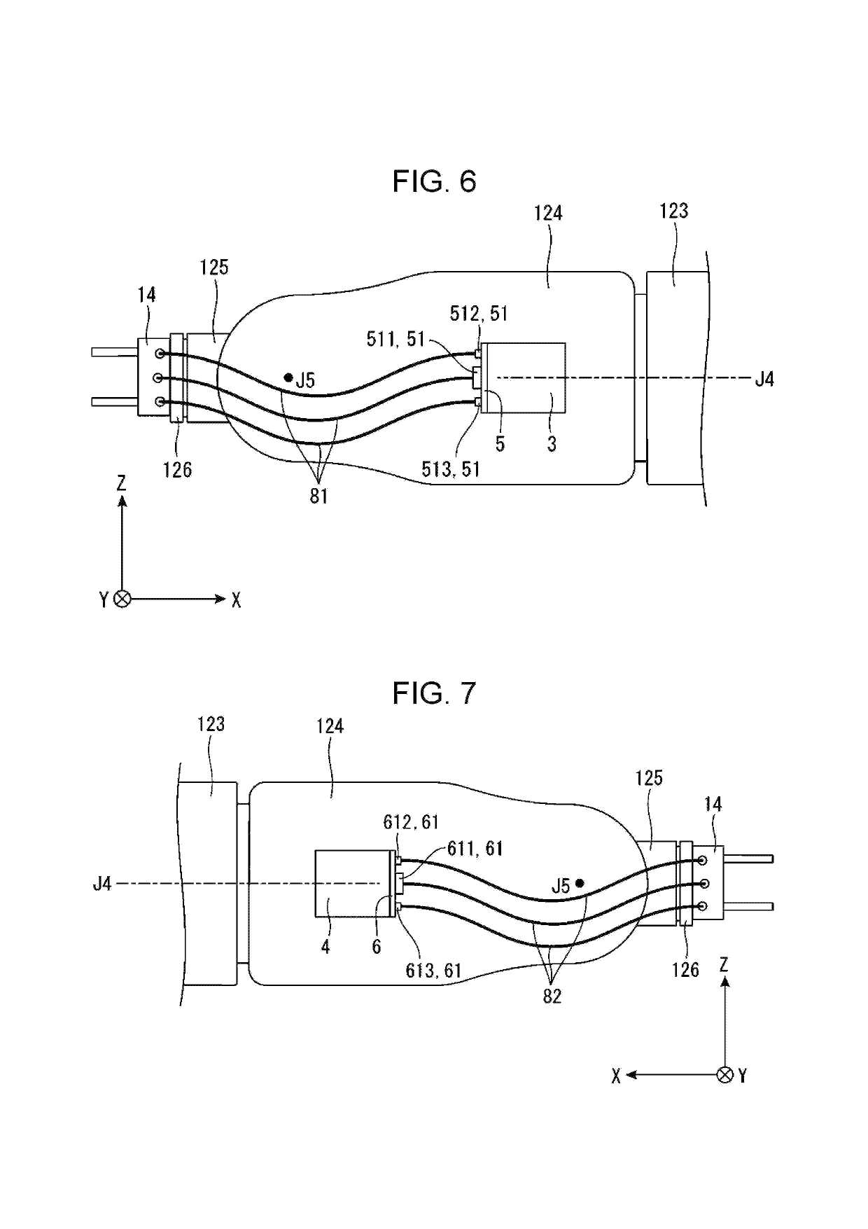

FIG. 1 is a side view illustrating a vertical articulated robot according to a preferred embodiment. FIG. 2 is a sectional view of arms included in the vertical articulated robot illustrated in FIG. 1. FIG. 3 is a sectional view illustrating a configuration of drive units. FIG. 4 is a plan view of arms for explaining a problem with a structure in the related art. FIG. 5 is a plan view of arms. FIGS. 6 and 7 are side views, each illustrating a state in which arms and a hand are coupled with wires.

The vertical articulated robot 1 illustrated in FIG. 1 includes a base 11 fixed to a floor or the like, a robot arm 12 rotatably coupled to the base 11, a hand 14 attached to a distal end of the robot arm 12, and a control device 15.

The robot arm 12 includes: an arm 121 coupled rotatably around a rotation axis J1 with respect to the base 11; an arm 122 coupled around a rotation axis J2 that is orthogonal to the rotation axis J1 with respect to the arm 121; an arm 123 as a first arm coupled rotatably around a rotation axis J3 that is parallel to the rotation axis J2 with respect to the arm 122; an arm 124 as a second arm coupled rotatably around a rotation axis J4 as a first rotation axis that is orthogonal to the rotation axis J3 with respect to the arm 123; an arm 125 as a third arm coupled rotatably around a rotation axis J5 as a second rotation axis that is orthogonal to the rotation axis J4 with respect to the arm 124; and an arm 126 coupled rotatably around a rotation axis J6 that is orthogonal to the rotation axis J5 with respect to the arm 125. In addition, the hand 14 is attached to the arm 126. The hand 14 is detachable with respect to the arm 126, and a hand suitable for the type of work performed by the vertical articulated robot 1 is selectively attached. Note that the rotation axes J1 to J6 are virtual lines.

Further, the vertical articulated robot 1 includes: a drive unit 131 for rotating the arm 121 around the rotation axis J1 with respect to the base 11; a drive unit 132 for rotating the arm 122 around the rotation axis J2 with respect to the arm 121; a drive unit 133 for rotating the arm 123 around the rotation axis J3 with respect to the arm 122; a drive unit 134 for rotating the arm 124 around the rotation axis J4 with respect to the arm 123; a drive unit 135 for rotating the arm 125 around the rotation axis J5 with respect to the arm 124; and a drive unit 136 for rotating the arm 126 around the rotation axis J6 with respect to the arm 125. Each of the drive units 131 to 136 includes, for example, a motor which is a drive source, a speed reducer which decelerates the rotation of the motor and increases and outputs a rotational force (torque), an encoder which detects the amount of rotation of the motor, and the like.

In addition, the control device 15 independently controls driving of the motors provided in each of the drive units 131 to 136 and controls driving of the hand 14. The control device 15 is constituted by, for example, a computer, and includes a central processing unit (CPU), a random access memory (RAM), a read only memory (ROM) in which a program is stored, and the like. The CPU reads and executes the program stored in the ROM, and thereby a function of the control device 15 that controls driving of the vertical articulated robot 1 is achieved.

The overall configuration of the vertical articulated robot 1 has been briefly described above. Next, the configuration of the arm 124, which is also a feature of the vertical articulated robot 1, will be described in detail with reference to FIGS. 2 to 7. For convenience of description, in each drawing of FIGS. 2 to 7, three axes orthogonal to each other are illustrated as an X-axis, a Y-axis, and a Z-axis. In addition, hereinafter, for convenience of description, a direction parallel to the X-axis will be referred to as an "X-axis direction", a direction parallel to the Y-axis will be referred to as a "Y-axis direction", and a direction parallel to the Z-axis will be referred to as a "Z-axis direction". The arrow side of each axis is also referred to as a "plus side", and the opposite side is also referred to as a "minus side".

As illustrated in FIG. 2, the arm 124 is rotatably coupled to a distal end portion of the arm 123 and extends along the rotation axis J4. The arm 124 includes a housing 2, and a first wire lead-out portion 3 and a second wire lead-out portion 4 that are disposed on the housing 2.

Further, the housing 2 includes an arm main body 21 coupled to the arm 123 via a speed reducer T4 included in the drive unit 134, and a first cover member 22 and a second cover member 23 fixed to the arm main body 21. Then, first wires 91 and second wires 92 are routed from the inside of the arm 123 to the inside of the housing 2 through the inside of the speed reducer T4. Specifically, the speed reducer T4 is, for example, a wave gear device and includes a circular spline T41 fixed to the arm 123, a flex spline T42 fixed to the arm 124 (arm main body 21), and a wave generator T43 coupled to a motor (not shown) included in the drive unit 134. In addition, the wave generator T43 has a tubular shape. Therefore, each of the first and second wires 91 and 92 is routed from the inside of the arm 123 to the inside of the housing 2 through the inside of the wave generator T43.

Although not illustrated, the first and second wires 91 and 92 are routed to the inside of the base 11 through the arms 122 and 121, and are coupled to the control device 15 and the like via a connector group formed on a back side of the base 11.

Here, each of the first and second wires 91 and 92 is not particularly limited, and may be, for example, an electrical wire for transmitting and receiving an electric signal, a compressed air pipe for supplying compressed air, or a liquid pipe for supplying a liquid, or may be a wire or a pipe having other functions. In addition, each of the number of first wires 91 and the number of second wires 92 is not particularly limited, and may be one, or two or more. Further, the numbers of first and second wires 91 and 92 may be equal to each other or may be different from each other. However, in the present embodiment, each of the number of first wires 91 and the number of second wires 92 is three, one of which is an electrical wire 911 or 921, and the other two of which are compressed air pipes 912 or 922. With such a configuration, the first wires 91 and the second wires 92 are balanced, and as will be described later, a deviation of a center of gravity of the arm 124 can be effectively suppressed.

The arm main body 21 is a highly rigid member made of a metal material and the like, and has a tubular shape having openings 211 and 212 on both side surfaces in the Y-axis direction. By forming the arm main body 21 in the tubular shape, the drive units 135 and 136 can be easily mounted in the arm main body 21.

The first cover member 22 is a lightweight member made of a resin material and the like, and is fixed to a side surface on one side (a minus side in the Y-axis direction) of the arm main body 21 so as to close the opening 211 of the arm main body 21. Similarly to the first cover member 22, the second cover member 23 is a lightweight member made of a resin material and the like, and is fixed to a side surface on the other side (a plus side in the Y-axis direction) of the arm main body 21 so as to close the opening 212 of the arm main body 21. In this way, by making the first and second cover members 22 and 23 out of a lightweight resin material, the weight of the arm 124 can be reduced and the motion performance of the robot arm 12 can be improved. However, the constituent materials of the first and second cover members 22 and 23 are not particularly limited. For example, the first and second cover members 22 and 23 may be formed of lightweight metal materials such as aluminum or stainless steel.

In addition, a first opening 221 is formed in the first cover member 22, and the first wires 91 are led out to the outside of the housing 2 through the first opening 221. Similarly, a second opening 231 is formed in the second cover member 23, and the second wires 92 are led out to the outside of the housing 2 through the second opening 231.

Meanwhile, the drive units 135 and 136 disposed in the arm 124 will be described with reference to FIG. 3.

The drive unit 135 rotates the arm 125 around the rotation axis J5 with respect to the arm 124, and includes a speed reducer T5 which rotatably couples the arms 124 and 125, a motor M5 as a third arm drive motor, an encoder E5 which detects the amount of rotation of the motor M5, and a power transmission unit D5 which transmits power of the motor M5 to the speed reducer T5.

The motor M5 is disposed such that an output shaft M51 faces the minus side in the Y-axis direction and the output shaft M51 is parallel to the rotation axis J5. The speed reducer T5 is a wave gear device, and includes a circular spline T51 fixed to the arm 124, a flex spline T52 fixed to the arm 125, and a wave generator T53 coupled to the motor M5 via the power transmission unit D5. In addition, the power transmission unit D5 includes a pulley D51 disposed on the output shaft M51, a pulley D52 disposed on the wave generator T53, and a belt D53 wound around the pulleys D51 and D52.

Therefore, when the motor M5 is driven, the rotation of the output shaft M51 is transmitted to the wave generator T53 via the pulley D51, the belt D53, and the pulley D52, and the wave generator T53 rotates. Further, the flex spline T52 rotates at a predetermined speed reduction ratio with respect to the rotation of the wave generator T53, and as a result, the arm 125 rotates around the rotation axis J5 with respect to the arm 124.

The drive unit 136 rotates the arm 126 around the rotation axis J6 with respect to the arm 125, and includes a motor M6, an encoder E6 which detects the amount of rotation of the motor M6, and a power transmission unit D6 which transmits power of the motor M6 to the arm 126.

The motor M6 is disposed such that an output shaft M61 faces the plus side in the Y-axis direction and the output shaft M61 is parallel to the rotation axis J5. In addition, the motor M6 is disposed so as to overlap the motor M5 in the Z-axis direction. Further, the power transmission unit D6 includes a pulley D61 disposed on the output shaft M61, a pulley D62 rotatably supported by the arms 124 and 125 around the rotation axis J5, a belt D63 wound around the pulleys D61 and D62, an input-side bevel gear D64 which rotates with the pulley D62 around the rotation axis J5, and an output-side bevel gear D65 which engages with the input-side bevel gear D64 and rotates with the arms 126 around the rotation axis J6.

Therefore, when the motor M6 is driven, the rotation of the output shaft M61 is transmitted to the arm 126 via the power transmission unit D6, and as a result, the arm 126 rotates around the rotation axis J6 with respect to the arm 125.

The drive units 135 and 136 have been described above. However, the configuration of the drive unit 135 is not particularly limited insofar as the arm 125 can be rotated around the rotation axis J5 with respect to the arm 124. Similarly, the configuration of the drive unit 136 is not particularly limited insofar as the arm 126 can be rotated around the rotation axis J6 with respect to the arm 125.

Returning to the description of the arm 124 again, as illustrated in FIG. 2, the first and second openings 221 and 231 formed in the first and second cover members 22 and 23 are located closer to a proximal end, that is, closer to the arm 123, than are the pulleys D51 and D61 included in the drive units 135 and 136. In this way, by disposing the first and second openings 221 and 231 closer to the proximal end than are the pulleys D51 and D61, the contact between the pulleys D51 and D61 and the first and second wires 91 and 92 can be effectively suppressed. Therefore, disconnection of the first and second wires 91 and 92 can be effectively suppressed. However, the disposition of the first and second openings 221 and 231 is not particularly limited. For example, the first and second openings 221 and 231 may be disposed side by side with the pulleys D51 and D61 in the Y-axis direction, or may be disposed closer to the distal end, that is, closer to the arm 125, than are the pulleys D51 and D61.

The housing 2 has been described above. Next, the first wire lead-out portion 3 and the second wire lead-out portion 4 disposed on the housing 2 will be described.

The first wire lead-out portion 3 is fixed to the first cover member 22 so as to cover the first opening 221 formed in the first cover member 22. The first wire lead-out portion 3 leads out the first wires 91 to the outside of the housing 2 through the first opening 221. Similarly, the second wire lead-out portion 4 is fixed to the second cover member 23 so as to cover the second opening 231 formed in the second cover member 23. The second wire lead-out portion 4 leads out the second wires 92 to the outside of the housing 2 through the second opening 231. The first and second wire lead-out portions 3 and 4 are both lightweight members made of a resin material and the like. Therefore, a weight increase of the arm 124 due to the disposition of the first and second wire lead-out portions 3 and 4 can be effectively suppressed. However, the constituent materials of the first and second wire lead-out portions 3 and 4 are not particularly limited. For example, the first and second wire lead-out portions 3 and 4 may be formed of lightweight metal materials such as aluminum or stainless steel.

In addition, the first wire lead-out portion 3 and the second wire lead-out portion 4 are disposed to face each other across the rotation axis J4. That is, the first wire lead-out portion 3 and the second wire lead-out portion 4 are disposed on the sides opposite to each other with respect to the rotation axis J4. With such a configuration, the first wire lead-out portion 3 and the second wire lead-out portion 4 are disposed on both sides of the arm 124 in a balanced manner. Therefore, a deviation of the center of gravity of the arm 124, that is, a shift of the center of gravity of the arm 124 from the rotation axis J4, can be effectively suppressed. As a result, a decrease in performance of the operation of the arm 124 can be effectively suppressed.

In addition, for example, as illustrated in FIG. 4, in a configuration as in the related art in which only one of the first and second wire lead-out portions 3 and 4 (hereinafter referred to as the first wire lead-out portion 3) is provided and the first and second wires 91 and 92 are collectively led out together from the first wire lead-out portion 3, the number of wires passing through the first wire lead-out portion 3 increases, and as the number of wires increases, the first wire lead-out portion 3 becomes larger. Therefore, a radius of rotation r around the rotation axis J4 of the arm 124 becomes larger, which leads to an increased self-interference region, and the operable range becomes smaller. In addition, as the radius of rotation r becomes larger, the deviation of the center of gravity of the arm 124 increases and the operation performance decreases.

On the other hand, in the vertical articulated robot 1, the first and second wire lead-out portions 3 and 4 are disposed on both sides of the arm 124, the first wires 91 are led out from the first wire lead-out portion 3, and the second wires 92 are led out from the second wire lead-out portion 4. Therefore, the size of each of the first and second wire lead-out portions 3 and 4 can be reduced, and as illustrated in FIG. 5, the radius of rotation r around the rotation axis J4 of the arm 124 becomes smaller, which leads to a reduced self-interference region, and the operable range becomes larger. In addition, as the radius of rotation r becomes smaller, the deviation of the center of gravity of the arm 124 decreases and the operation performance improves. Furthermore, by dividing the wires in the housing 2 into the first wires 91 led out from the first wire lead-out portion 3 and the second wires 92 led out from the second wire lead-out portion 4, the number of wires passing through the first and second wire lead-out portions 3 and 4 can be reduced. Therefore, stress is less likely to be applied to the first and second wires 91 and 92, and excessive bending or disconnection of the first and second wires 91 and 92 can be effectively suppressed.

In particular, in the present embodiment, the first wire lead-out portion 3 and the second wire lead-out portion 4 have the same shape as each other. Therefore, the first wire lead-out portion 3 and the second wire lead-out portion 4 have the same mass, and the deviation of the center of gravity of the arm 124 can be more effectively suppressed. In addition, common components can be used, and the manufacturing cost of the vertical articulated robot 1 can be reduced. Furthermore, the radius of rotation r around the rotation axis J4 of the arm 124 can be suppressed to be smaller than in a case where the first wire lead-out portion 3 and the second wire lead-out portion 4 have different shapes. As the radius of rotation r becomes smaller, the deviation of the center of gravity of the arm 124 is reduced and the operation performance is improved. However, without being limited thereto, the first wire lead-out portion 3 and the second wire lead-out portion 4 may have shapes different from each other.

Further, as illustrated in FIG. 5, in the present embodiment, in plan view in the direction along the rotation axis J4, that is, in plan view in the X-axis direction, outer edges 30 and 40 of the first and second wire lead-out portions 3 and 4 are curved in arc shapes along a circle C which has the rotation axis J4 as a center. With such a shape, the radius of rotation r around the rotation axis J4 of the arm 124 can be further reduced. As the radius of rotation r becomes smaller, the deviation of the center of gravity of the arm 124 is reduced and the operation performance is improved. However, without being limited thereto, the outer edges 30 and 40 of the first and second wire lead-out portions 3 and 4 may not be along the circle C.

Further, as illustrated in FIG. 2, the arm 124 includes a first partition wall portion 241 that partitions between the first wires 91 in the first wire lead-out portion 3 and the pulley D51, and a second partition wall portion 242 that partitions between the second wires 92 in the second wire lead-out portion 4 and the pulley D61. The first partition wall portion 241 is formed of the first cover member 22 and the first wire lead-out portion 3, and is interposed between the first wires 91 in the first wire lead-out portion 3 and the pulley D51. With such a configuration, the contact between the pulley D51 and the first wires 91 can be effectively suppressed by the first partition wall portion 241. Therefore, disconnection of the first wires 91 can be effectively suppressed. Similarly, the second partition wall portion 242 is formed of the second cover member 23 and the second wire lead-out portion 4, and is interposed between the second wires 92 in the second wire lead-out portion 4 and the pulley D61. With such a configuration, the contact between the pulley D61 and the second wires 92 can be effectively suppressed by the second partition wall portion 242. Therefore, disconnection of the second wires 92 can be effectively suppressed. However, without being limited thereto, the first and second partition wall portions 241 and 242 may be omitted.

In addition, as illustrated in FIGS. 2 and 5, a first connector support portion 5 which supports a plurality of first connectors 51 coupled to the first wires 91 is disposed at the distal end portion of the first wire lead-out portion 3. In addition, the first connector support portion 5 is screwed to the first wire lead-out portion 3, and has a shape which does not protrude from the first wire lead-out portion 3 in plan view in a direction along the rotation axis J4. Further, in the present embodiment, since the number of first wires 91 is three, the number of first connectors 51 is also three accordingly. Specifically, the first connectors 51 include a first connector 511 to which the electrical wire 911 is coupled, a first connector 512 to which one of the compressed air pipes 912 is coupled, and a first connector 513 to which the other compressed air pipe 912 is fixed. As illustrated in FIG. 6, the first connectors 511, 512, and 513 are coupled to the hand 14 via coupling wires 81. The first connector 511 is not particularly limited, and is, for example, a D-sub connector or an Ethernet connector, or the like.

In addition, as illustrated in FIG. 5, of the three first connectors 51, the first connector 511 is the largest, and the first connectors 512 and 513 are smaller than the first connector 511. The first connector 511 as the largest first connector is disposed in a central portion of the first connector support portion 5, and the other first connectors 512 and 513 are disposed around the first connector 511. Specifically, the first connector 512 is disposed on an upper side (the plus side in the Z-axis direction) of the first connector 511, and the first connector 513 is disposed on a lower side (the minus side in the Z-axis direction) of the first connector 511.

As described above, since the outer edge 30 of the first wire lead-out portion 3 is curved in the arc shape, the width (a length in the Y-axis direction) of the first connector support portion 5 is the widest in the central portion and becomes narrower toward the upper and lower end portions. Therefore, by disposing the largest first connector 511 in the central portion and disposing the other first connectors 512 and 513 on the upper and lower sides thereof, the first connectors 511, 512, and 513 can be disposed on the first connector support portion 5 in a balanced manner, and the size of the first connector support portion 5 can be reduced. In addition, by disposing the largest first connector 511 in the central portion, the deviation of the center of gravity of the arm 124 can be effectively suppressed.

Further, as illustrated in FIGS. 2 and 5, a second connector support portion 6 which supports a plurality of second connectors 61 coupled to the second wires 92 is disposed at the distal end portion of the second wire lead-out portion 4. The second connector support portion 6 has the same configuration as that of the first connector support portion 5. The second connector support portion 6 is screwed to the second wire lead-out portion 4, and has a shape which does not protrude from the second wire lead-out portion 4 in plan view in a direction along the rotation axis J4. In addition, in the present embodiment, since the number of second wires 92 is three, the number of second connectors 61 is also three accordingly. Specifically, the second connector 61 includes a second connector 611 to which the electrical wire 921 is coupled, a second connector 612 to which one of the compressed air pipes 922 is coupled, and a second connector 613 to which the other compressed air pipe 922 is fixed. As illustrated in FIG. 7, the second connectors 611, 612, and 613 are coupled to the hand 14 via the coupling wire 82. The second connector 611 is not particularly limited, and is, for example, a D-sub connector or an Ethernet connector, or the like.

Further, as illustrated in FIG. 5, of the three second connectors 61, the second connector 611 is the largest, and the second connectors 612 and 613 are smaller than the second connector 611. In addition, the second connector 611 as the largest second connector is disposed in a central portion of the second connector support portion 6, and the other second connectors 612 and 613 are disposed around the second connector 611. Specifically, the second connector 612 is disposed on an upper side of the second connector 611, and the second connector 613 is disposed on a lower side of the second connector 611.

As described above, since the outer edge 40 of the second wire lead-out portion 4 is curved in the arc shape, the width (a length in the Y-axis direction) of the second connector support portion 6 is the widest in the central portion and becomes narrower toward the upper and lower end portions. Therefore, by disposing the largest second connector 611 in the central portion and disposing the other second connectors 612 and 613 on the upper and lower sides thereof, the second connectors 611, 612, and 613 can be disposed in the second connector support portion 6 in a balanced manner, and the size of the second connector support portion 6 can be reduced. In addition, by disposing the largest second connector 611 in the central portion, the deviation of the center of gravity of the arm 124 can be effectively suppressed.

The first and second connector support portions 5 and 6 have been described above. As mentioned above, in the present embodiment, the number of first connectors 51 is equal to the number of second connectors 61. In this way, by making the number of first connectors 51 and the number of second connectors 61 equal, the connectors can be disposed in a balanced manner on the first and second wire lead-out portions 3 and 4, and both the first and second wire lead-out portions 3 and 4 can be reduced in size. Therefore, the radius of rotation r around the rotation axis J4 of the arm 124 can be reduced.

In addition, as illustrated in FIG. 5, the rotation axis J4 and the rotation axis J5 are orthogonal to each other, and each of the first wire lead-out portion 3 and the second wire lead-out portion 4 overlaps with the rotation axis J5 in plan view in a direction along the rotation axis J4, that is, in plan view in the X-axis direction. With such a configuration, for example, a wire length L1 of the coupling wires 81 and 82 necessary when the arm 125 is rotated to the plus side in the Z-axis direction with respect to the arm 124 is substantially the same as a wire length L2 of the coupling wires 81 and 82 necessary when the arm 125 is rotated to the minus side in the Z-axis direction with respect to the arm 124. Therefore, the wire lengths of the coupling wires 81 and 82 can be easily determined. In a case when the wire length L1 is longer than the wire length L2, the wire lengths of the coupling wires 81 and 82 must be determined in accordance with the wire length L1. Therefore, when the arm 125 is rotated to the minus side in the Z-axis direction with respect to the arm 124, there is a concern that excessive bending of the coupling wires 81 and 82 may occur and workability may deteriorate. On the other hand, in the present embodiment, even when the arm 125 is rotated to the plus side in the Z-axis direction with respect to the arm 124, or even when the arm 125 is rotated to the minus side in the Z-axis direction, the coupling wires 81 and 82 are not excessively bent, and thus the workability is not deteriorated. However, without being limited thereto, each of the first wire lead-out portion 3 and the second wire lead-out portion 4 may be disposed so as not to overlap with the rotation axis J5 in plan view in the X-axis direction. For example, each of the first wire lead-out portion 3 and the second wire lead-out portion 4 may be disposed so as to overlap with the virtual line, such as an orthogonal virtual line, which intersects with the rotation axis J5.

The first and second wire lead-out portions 3 and 4 have been described above. The first and second wire lead-out portions 3 and 4 are detachably fixed to the housing 2 by, for example, screwing or the like. Accordingly, for example, the first and second wire lead-out portions 3 and 4 can be appropriately replaced depending on the number and type of first and second wires 91 and 92. In addition, for example, for a user who does not require the first and second wire lead-out portions 3 and 4, it is possible to provide the vertical articulated robot 1 in a state where the first and second wire lead-out portions 3 and 4 are removed, and instead, the first and second openings 221 and 231 are covered with plate-shaped covers. In this way, by making the first and second wire lead-out portions 3 and 4 detachable from the housing 2, customization of the vertical articulated robot 1 is facilitated.

The vertical articulated robot 1 has been described above. As described above, the vertical articulated robot 1 includes: the arm 123 as the first arm; the arm 124 as the second arm coupled to the distal end portion of the arm 123, configured to rotate around the rotation axis J4 which is the first rotation axis with respect to the arm 123, and extending along the rotation axis J4; and the arm 125 as the third arm coupled to the distal end portion of the arm 124 and configured to rotate around the rotation axis J5 which is the second rotation axis with respect to the arm 124. In addition, the arm 124 includes: the housing 2 coupled to the arm 123; the first wire lead-out portion 3 disposed on the housing 2 and leading out the first wires 91, which are routed from the inside of the arm 123 to the inside of the housing 2, to the outside of the housing 2; and the second wire lead-out portion 4 disposed on the housing 2 and leading out the second wires 92, which are routed from the inside of the arm 123 to the inside of the housing 2, to the outside of the housing 2. The first wire lead-out portion 3 and the second wire lead-out portion 4 are disposed to face each other across the rotation axis J4. With such a configuration, the first wire lead-out portion 3 and the second wire lead-out portion 4 are disposed on both sides of the arm 124 in a balanced manner. Therefore, a deviation of the center of gravity of the arm 124, that is, a shift of the center of gravity of the arm 124 from the rotation axis J4, can be effectively suppressed. As a result, a decrease in performance of the operation of the arm 124 can be effectively suppressed.

In addition, as described above, the rotation axis J4 and the rotation axis J5 intersect with each other, and each of the first wire lead-out portion 3 and the second wire lead-out portion 4 overlaps with the rotation axis J5 in plan view in the direction along the rotation axis J4. With such a configuration, the wire length L1 of the coupling wires 81 and 82 necessary when the arm 125 is rotated to the plus side in the Z-axis direction with respect to the arm 124 is substantially the same as the wire length L2 of the coupling wires 81 and 82 necessary when the arm 125 is rotated to the minus side in the Z-axis direction with respect to the arm 124. Therefore, the wire lengths of the coupling wires 81 and 82 can be easily determined.

In addition, as described above, the vertical articulated robot 1 includes the motor M5 as the third arm drive motor disposed in the arm 124 and configured to rotate the arm 125 around the rotation axis J5 with respect to the arm 124, and the power transmission unit D5 including the pulley D51 disposed on the output shaft M51 of the motor M5 and configured to transmit the rotation of the output shaft M51 to the arm 125. In addition, the arm 124 includes the first opening 221 through which the inside of the housing 2 communicates with the inside of the first wire lead-out portion 3 and through which the first wires 91 are inserted, and the second opening 231 through which the inside of the housing 2 communicates with the inside of the second wire lead-out portion 4 and through which the second wires 92 are inserted. Each of the first opening 221 and the second opening 231 is located closer to the arm 123 than is the pulley D51. With such a configuration, the contact between the pulley D51 and the first and second wires 91 and 92 can be effectively suppressed. Therefore, disconnection of the first and second wires 91 and 92 can be effectively suppressed.

In addition, as described above, the arm 124 includes the first partition wall portion 241 that partitions between the first wires 91 in the first wire lead-out portion 3 and the pulley D51, and the second partition wall portion 242 that partitions between the second wires 92 in the second wire lead-out portion 4 and the pulley D61. With such a configuration, the contact between the pulleys D51 and D61 and the first and second wires 91 and 92, respectively, can be effectively suppressed by the first and second partition wall portions 241 and 242. Therefore, disconnection of the first and second wires 91 and 92 can be effectively suppressed.

As described above, each of the first wire lead-out portion 3 and the second wire lead-out portion 4 is detachable from the arm 124. With such a configuration, the first and second wire lead-out portions 3 and 4 can be appropriately replaced depending on the number and type of first and second wires 91 and 92. In addition, for example, for a user who does not need the first and second wire lead-out portions 3 and 4, it is possible to easily provide the vertical articulated robot 1 to which the first and second wire lead-out portions 3 and 4 are not attached. Therefore, customization of the vertical articulated robot 1 is facilitated.

Further, as described above, the first wire lead-out portion 3 and the second wire lead-out portion 4 have the same shape as each other. With such a configuration, a deviation of the center of gravity of the arm 124 can be effectively suppressed. In addition, since common components can be used, the manufacturing cost of the vertical articulated robot 1 can be reduced.

In addition, as described above, the vertical articulated robot 1 includes the first connector support portion 5 disposed on the first wire lead-out portion 3 and supporting the first connectors 51 coupled to the first wires 91, and the second connector support portion 6 disposed on the second wire lead-out portion 4 and supporting the second connectors 61 coupled to the second wires 92. The number of first connectors 51 and the number of second connectors 61 are equal. With such a configuration, the connectors can be disposed in the first and second wire lead-out portions 3 and 4 in a balanced manner, and both the first and second wire lead-out portions 3 and 4 can be reduced in size. Therefore, the radius of rotation r around the rotation axis J4 of the arm 124 can be reduced.

In addition, as described above, the plurality of first connectors 51 having different sizes are disposed on the first connector support portion 5, and as the largest first connector, the first connector 511 which is the largest of the first connectors 51 is disposed in the central portion of the first connector support portion 5, and the first connectors 512 and 513 other than the first connector 511 are disposed around the first connector 511. Similarly, the plurality of second connectors 61 having different sizes are disposed on the second connector support portion 6, and as the largest second connector, the second connector 611 which is the largest of the second connectors 61 is disposed in the central portion of the second connector support portion 6, and the second connectors 612 and 613 other than the second connector 611 are disposed around the second connector 611. With such a configuration, the first connectors 511, 512, and 513 can be disposed on the first connector support portion 5 in a balanced manner, and the size of the first connector support portion 5 can be reduced. Similarly, the second connectors 611, 612, and 613 can be disposed on the second connector support portion 6 in a balanced manner, and the size of the second connector support portion 6 can be reduced. In addition, a deviation of the center of gravity of the arm 124 can be effectively suppressed.

The vertical articulated robot of the present disclosure has been described above based on the illustrated embodiments. Meanwhile, the present disclosure is not limited thereto, and the configuration of each unit can be replaced with any configuration having a similar function. In addition, any other components may be added to the present disclosure. In addition, the embodiments described above may be appropriately combined with each other.

1. A vertical articulated robot comprising:
a first arm;
a second arm coupled to a distal end portion of the first arm, configured to rotate around a first rotation axis with respect to the first arm, and extending along the first rotation axis; and
a third arm coupled to a distal end portion of the second arm and configured to rotate around a second rotation axis with respect to the second arm,
the second arm including:
a housing coupled to the first arm; and
a first wire lead-out portion and a second wire lead-out portion disposed on the housing, the first wire lead-out portion leading out a first wire to an outside of the housing, the first wire being routed from an inside of the first arm to an inside of the housing, the second wire lead-out portion leading out a second wire to the outside of the housing, the second wire being routed from the inside of the first arm to the inside of the housing, wherein
the first wire lead-out portion and the second wire lead-out portion are disposed to face each other across the first rotation axis.

2. The vertical articulated robot according to claim 1, wherein
the first rotation axis and the second rotation axis intersect with each other, and
each of the first wire lead-out portion and the second wire lead-out portion overlaps with the second rotation axis in plan view in a direction along the first rotation axis.

3. The vertical articulated robot according to claim 1, further comprising:
a third arm drive motor disposed in the second arm and configured to rotate the third arm around the second rotation axis with respect to the second arm; and
a power transmission unit including a pulley disposed on an output shaft of the third arm drive motor and configured to transmit rotation of the output shaft to the third arm,
the second arm including:
a first opening through which the inside of the housing communicates with an inside of the first wire lead-out portion, and through which the first wire is inserted; and
a second opening through which the inside of the housing communicates with an inside of the second wire lead-out portion, and through which the second wire is inserted, wherein
each of the first opening and the second opening is located closer to the first arm than is the pulley.

4. The vertical articulated robot according to claim 3, wherein
the second arm includes a first partition wall portion partitioning between the first wire in the first wire lead-out portion and the pulley, and a second partition wall portion partitioning between the second wire in the second wire lead-out portion and the pulley.

5. The vertical articulated robot according to claim 1, wherein
each of the first wire lead-out portion and the second wire lead-out portion is detachable from the second arm.

6. The vertical articulated robot according to claim 1, wherein
the first wire lead-out portion and the second wire lead-out portion have a same shape as each other.

7. The vertical articulated robot according to claim 1, further comprising:
a first connector support portion disposed on the first wire lead-out portion and supporting a first connector coupled to the first wire; and
a second connector support portion disposed on the second wire lead-out portion and supporting a second connector coupled to the second wire, wherein
a number of the first connector and a number of the second connector are equal.

8. The vertical articulated robot according to claim 7, wherein
the first connector includes a plurality of first connectors having different sizes and disposed on the first connector support portion,
a largest first connector that is a largest of the first connectors is disposed in a central portion of the first connector support portion, and the first connectors other than the largest first connector are disposed around the largest first connector,
the second connector includes a plurality of second connectors having different sizes and disposed on the second connector support portion, and
a largest second connector that is a largest of the second connectors is disposed in a central portion of the second connector support portion, and the second connectors other than the largest second connector are disposed around the largest second connector.

9. The vertical articulated robot according to claim 1, wherein
in plan view in a direction along the first rotation axis,
the first rotation axis and the second rotation axis intersect with each other, and each of the first wire lead-out portion and the second wire lead-out portion overlaps with the second rotation axis,
the vertical articulated robot further comprising:
a third arm drive motor disposed in the second arm and configured to rotate the third arm around the second rotation axis with respect to the second arm; and
a power transmission unit including a pulley disposed on an output shaft of the third arm drive motor and configured to transmit rotation of the output shaft to the third arm,
the second arm including:
a first opening through which the inside of the housing communicates with an inside of the first wire lead-out portion, and through which the first wire is inserted; and
a second opening through which the inside of the housing communicates with an inside of the second wire lead-out portion, and through which the second wire is inserted, wherein
each of the first opening and the second opening is located closer to the first arm than is the pulley,
the second arm includes a first partition wall portion partitioning between the first wire in the first wire lead-out portion and the pulley, and a second partition wall portion partitioning between the second wire in the second wire lead-out portion and the pulley, and
each of the first wire lead-out portion and the second wire lead-out portion is detachable from the second arm and has a same shape as each other,
the vertical articulated robot further comprising:
a first connector support portion disposed on the first wire lead-out portion and supporting a plurality of first connectors coupled to the first wire; and
a second connector support portion disposed on the second wire lead-out portion and supporting a plurality of second connectors coupled to the second wire, wherein
a number of the first connectors and a number of the second connectors are equal,
the plurality of first connectors have sizes different from each other, and a largest first connector that is a largest of the first connectors is disposed in a central portion of the first connector support portion, and the first connectors other than the largest first connector are disposed around the largest first connector, and
the plurality of second connectors have sizes different from each other, and a largest second connector that is a largest of the second connectors is disposed in a central portion of the second connector support portion, and the second connectors other than the largest second connector are disposed around the largest second connector.
